(19) United States
(12) Patent Application Publication
(10) Pub. No.: US 2019/0076866 A1
(43) Pub. Date: Mar. 14, 2019

(54) Industrial Cleaning System and Method

(71) Applicant: Agile Equipment, LLC, Dallas, TX (US)

(72) Inventor: David Stultz, Odessa, TX (US)

(73) Assignee: Agile Equipment, LLC, Dallas, TX (US)

(21) Appl. No.: 16/125,366

(22) Filed: Sep. 7, 2018

Related U.S. Application Data
(60) Provisional application No. 62/555,993, filed on Sep. 8, 2017.

(51) Int. Cl. B05B 12/08; B05B 12/10; B05B 12/00

(52) U.S. Cl. CPC B05B 12/087; B05B 12/10; B08B 3/026; B08B 2203/007; B08B 2203/0241; B05B 12/004

(57) ABSTRACT

A system for cleaning industrial equipment is disclosed. The system includes a tank, a first pump, at least two burners, an outlet line, a self-cleaning filter, and a second pump. The tank stores a fluid. The first pump increase pressure on the fluid. Two burners increase a temperature of the fluid. The outlet line to applies the increased temperature and increase pressure fluid as a fluid flow to industrial equipment, which includes radiator fins. The self-cleaning filter configured to remove potential contaminants from the fluid. The second pump circulates fluid in the system.

### RELATED APPLICATIONS

This application is related to U.S. Provisional Application Nos. 62/555,993 (filed on Sep. 8, 2017), which is incorporated by reference herein for all purposes. The present application hereby claims priority under 35 U.S.C. §119(e) to U.S. Provisional Application Nos. 62/555,993.

### TECHNICAL FIELD

This disclosure is generally directed to industrial cleaning technologies.

More specifically, this disclosure is directed to an industrial cleaning system and method.

### BACKGROUND

Over time, industrial equipment and surfaces can accumulate a variety of contaminants that negatively impact performance. This equipment and surfaces cannot be effectively removed with traditional methods due to either the nature of the contaminant and/or the sensitivity of the surface. Example contaminants include dust, mud, rust, microorganisms, grease oil, scale and other deposits. Example negative performance include, for example, equipment overheating, creating risk of damage to very expensive equipment, (ii) impairing ability to service equipment, and (iii) surfaces becoming dangerous and slippery.

Conventional cleaning of oil and gas equipment generally falls into three categories. A first category involves high pressure liquid-based washing. This type of cleaning is unfeasible because the high pressures (usually more than 1,000 psi) damages equipment that is ill-equipped to handle such high pressures.

A second category involves disassembly and rebuilding of the equipment to ensure equipment is not damaged. This type of cleaning is also infeasible because of the time involved.

A third newer category involves use of dry ice. However, this type of cleaning is infeasible as well. Not only is such cleaning cost intensive but it also is not as effective as the other categories because it can only be performed with ideal atmospherics and requires equipment to be pulled out of service in order to perform.

### BRIEF DESCRIPTION OF THE DRAWINGS

For a more complete understanding of this disclosure and its features, reference is now made to the following description, taken in conjunction with the accompanying drawings, in which:

FIG. 1 shows a high-level view of a cleaning system, according to an embodiment of the disclosure.

FIGS. 2A and 2B shows an example of cleaning radiator fins, according to an embodiment of the disclosure;

FIG. 3 shows a configuration of a system for delivering a fluid flow with thermal energy to industrial equipment such a radiator fins, according to an embodiment of the disclosure; and

FIG. 4 shows an example of the mobile nature equipment used to carry out the cleaning process, according to an embodiment of the disclosure.

### SUMMARY OF THE DISCLOSURE

According to an embodiment of the disclosure, an oil and gas application cleaning system and method has been developed that carefully applies a controlled fluid to clean oil field equipment. The system and method apply a high heat, high volume, low pressure fluid that effectively cleans while also avoiding damaging the equipment.

Stated simply, no other device exists that has the ability to offer this combination of temperature, flow and pressure.

According to an embodiment of the disclosure, a system for cleaning industrial equipment is disclosed. The system includes a tank, a first pump, at least two burners, an outlet line, a self-cleaning filter, and a second pump. The tank stores a fluid. The first pump increase pressure on the fluid. Two burners increase a temperature of the fluid. The outlet line to applies the increased temperature and increase pressure fluid as a fluid flow to industrial equipment, which includes delicate items, such as radiator fins. The self-cleaning filter removes potential contaminants from the fluid, which is critical in the operation of this application, as dirty water can lead to a breakdown of the equipment and/or a buildup of dangerous pressure. The second pump circulates fluid in the system.

According to another embodiment of the disclosure, method of cleaning a radiator fin comprises applying a fluid flow to a radiator fin from a nozzle at a rate of at least 12 gallons per minute, applying energy to increase a pressure of the fluid flow to between 290 pounds per square inch and 310 pounds per square at the nozzle, applying thermal energy to increase the temperature of the fluid to between 240° F. and 260° F. at the nozzle.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

It will be understood that well known processes and components have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

Additionally, although described in the context of oil and gas applications, other industrial processes can avail from the teachings of this disclosure.

As described above, conventional cleaning falls into three categories. A first category involves high pressure liquid-based washing. This type of cleaning is unfeasible because the high pressures (usually more than 1,000 psi) damages equipment that is ill-equipped to handle such high pressures.

A second category involves disassembly and rebuilding of the equipment to ensure equipment is not damaged. This type of cleaning is also infeasible because of the time involved.

A third newer category involves use of dry ice and/or soda blasting. However, this type of cleaning is infeasible as well. Not only is such cleaning cost intensive but is also not as effective as the other categories.

Teachings of certain embodiments of the disclosure recognize that industrial equipment can effectively cleaned using high thermal energy steam flow that are applied at lower pressures than liquid-based high-pressure applications that can damage equipment.

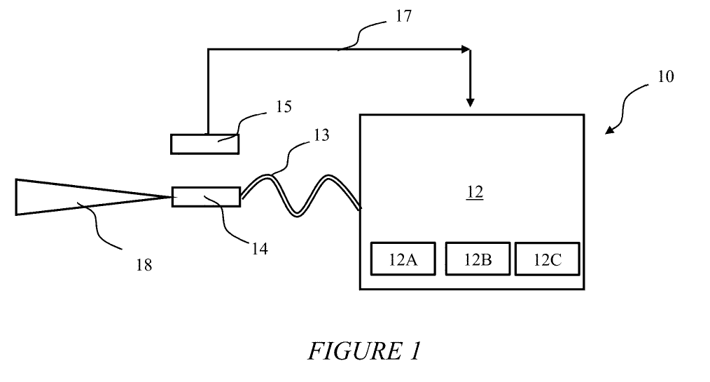

FIG. 1 shows a high-level view of a cleaning system 10, according to an embodiment of the disclosure. In general, a generating unit 12 provides a fluid through a hose 13 and a nozzle 14 to yield a fluid flow 18. As will be recognized by one of ordinary skill in the art, “fluid” refers to both vapor (or steam) and liquid phases. Thus, reference to “fluid” or “fluid flow” herein can include such fluid with different percentages of fluid in each phase. As described below, in particular configurations, the fluid can be up to 100% vapor, up to 100% liquid, and combinations of vapor and liquid therebetween.

In particular embodiments disclosed herein, the fluid flow 18 may be viewed as an efficient thermal energy (also referred to as heat) delivery vehicle that operates at low, non-equipment-damaging pressures. Such a fluid will be delivered at a relatively high flow volume. Accordingly, one may refer to the cleaning system 10 as a high heat, high flow volume, low pressure cleaning system.

In this figure, the generating unit 12 has three principal components: pressure 12A, thermal energy (or temperature) 12B, and fluid composition 12C. Because a particular desired fluid flow 18 may be desired, in particular embodiments, pressure 12A, thermal energy 12B, and fluid composition 12C can be modified according to a user's desired setting. And, the generating unit 12 can work to maintain a desired setting using input provided by a user. Additionally, because the ultimate fluid flow 18 is external to the generating unit 12, a sensor 15 may provide feedback to the generating unit 12 for analysis in determining whether modification is needed. The sensor 15 may have more than one sensor and sense the water content in the steam (e.g., vapor vs. liquid), temperature, and/or pressure. In certain configurations, the sensor 15 may also measure ambient temperature and pressure that can alter the makeup of the fluid flow 18. Although sensor 15 is shown in this configuration, other configurations may not have not have a sensor.

As will be described below, in certain embodiments, an activation mechanism near the nozzle 14 can provide feedback to the generating unit 12 to create a “dead head” effect in the generating unit 12. More specifically, the energy used in generating the thermal energy and pressure is shut off. According to such embodiments, such a “dead head” effect prevents the buildup of energy that can present significant safety concerns.

The pressure 12A may be modified using any suitable series of pumps, examples of which will be provided below. Likewise, the thermal energy 12B may be modified using any suitable heating mechanism, an example of which will be provided the below. The fluid composition 12C may have water, alone, or water in combination with other fluids. And, in certain configurations, a filtered form of water may be desired to avoid scale build up in not only the generating unit 12, but also the fluid flow 18.

In one configuration, the generating unit 12 may heat the fluid (e.g., which may be water) to between 240° F. and 260° F. and then flash it onto industrial equipment at or above 200° F. Different temperatures may be used in in other configurations. In one configuration, the generating unit 12 may apply to the fluid a pressure of 500 psi in the generating unit 12 or 300 psi at the tip of the nozzle 14. In other configurations, other pressures may be utilized. Such pressure is considered low relatively when compared to 2,000 to 4,000 PSI range for most common pressure washers. In one configuration, the generating unit 12 water may provide a fluid flow of between 12-14 gallons per minute.

Water at the aforementioned temperatures generally remain a liquid at pressures over 89.7 PSI. When the water flashes into steam at 212° F., the specific volume increases to 26.78 cubic ft./lb. The ratio of the final volume divided by the initial volume is 26.78/0.01765, which equates to 1,517 times its former volume. Therefore, when water condenses from steam towards a liquid in the steam flow 18, it expands to 1,517 times its former volume.

After the fluid in the cleaning system 10 passes through the nozzle 14, it is no longer under the additional pressure (e.g., caused by a pump in the generating unit 12) and cannot remain in its current state as water. Ten to fifteen percent of the water accordingly may flash into steam, cooling the mixture of steam and water. This steam vapor, used with a properly designed steam cleaning nozzle, also accelerates the remaining water droplets in the fluid flow 18.

Unlike a pressure washer nozzle, the steam cleaning nozzle 18 has an expansion zone placed past the pressure orifice, which directs the water vapor energy to a smaller area, instead of dissipating in all directions. The tremendous expansion is directed by the conical steam nozzle, accelerating the water droplets. The expansion nozzle's effect can be compared to that of the choke of a shotgun. Not only does the expansion nozzle direct the steam cleaner's output, it serves as a propulsion chamber. Accordingly, the expansion nozzle both directs and accelerates the output.

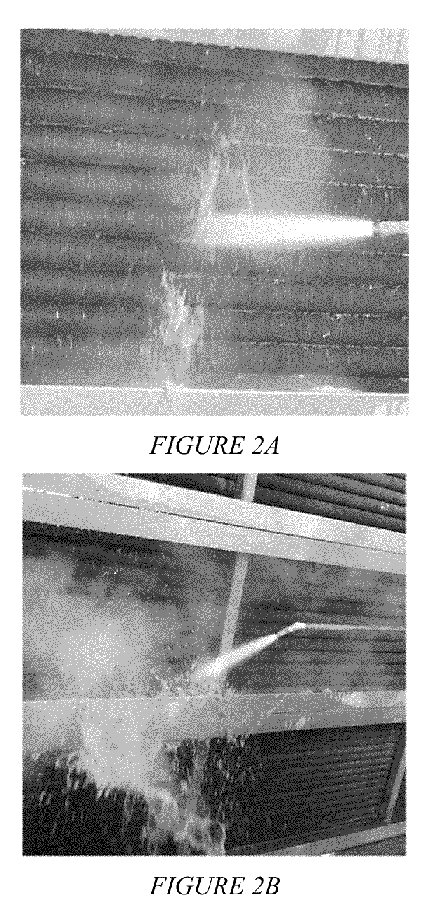

FIGS. 2A and 2B shows an example of cleaning radiator fins, according to an embodiment of the disclosure. Again, fluid exists in two states: liquid and vapor (or steam). In particular configurations, the flow of fluid is a combination of both liquid and vapor. In addition to water the fluid, itself, may contain other items such as cleaning materials that may enhance the cleaning process. In yet other configurations, there may no water or only water.

According to particular configurations, the thermal energy contained with fluid flow enhances the effect of cleaning. For example, some chemicals are more effective at higher temperatures at higher temperatures provided by the thermal energy in the steam cleaning, making emulsification of soils easier. Viewed from one perspective, the water serves as the delivery vehicle for thermal energy to enhance contaminant removal. tAs referenced above, in certain configurations, other fluids may be utilized—including, in some configurations, fluids other than water.

According to configurations, the flow of steam may be controlled based on a variety of mechanisms. As an example, steam may be generated and carefully pressurized and released via valves and/or pumps to create the desired flow. In particular configurations, the amount of thermal energy applied may also be controlled.

Turning back to example application of FIGS. 2A and 2B, so-called “fin fans” are constructed of finned tubes that are arranged in bundles with very limited space between them. Typically, each bundle is constructed from 4 to 12 layers of finned tubes, the fins are usually made of aluminum or copper with high heat transfer coefficients. Over time, the thin fins and the gaps between tubes may accumulate contaminants, such as dust, mud, sand, hardened calcium carbonate, organic materials like oil or polymers, and other deposits that significantly reduce the thermal efficiency of the heat exchanger, resulting higher process outlet temperatures; high energy consumptions and production bottlenecks. A goal is to have the fluid delivery vehicle provide thermal energy to the fins in a manner that doesn't damage them. A temperature of over 200° F. at the radiator fin can loosen the bonds of the contaminants and/or deposits.

FIGS. 2A and 2B show the effective and non-damaging removal of contaminants on the fin fans with the fluid flow. After removal, some of the steam has condensed and mixed with the contaminants to form a liquid mixture falling away from the fins.

In particular configurations, the cleaning is performed while the equipment is still on-line. Stated in another way, one may not need to turn of the equipment and instead can allow it to continue operate. This beneficially avoids any downtime costs.

In particular configurations, the designed mixture in a steam may be such that condensation/vaporization point occurs at a different temperature. One may manipulate such a mixture to modify applications.

As a partial recapitulation of some of the modifiable parameters, configurations, one may modify the thermal energy in the fluid, the volume rate of the fluid in its application, and a mixture in the fluid (e.g., as between solely water, a water mixture, or something else).

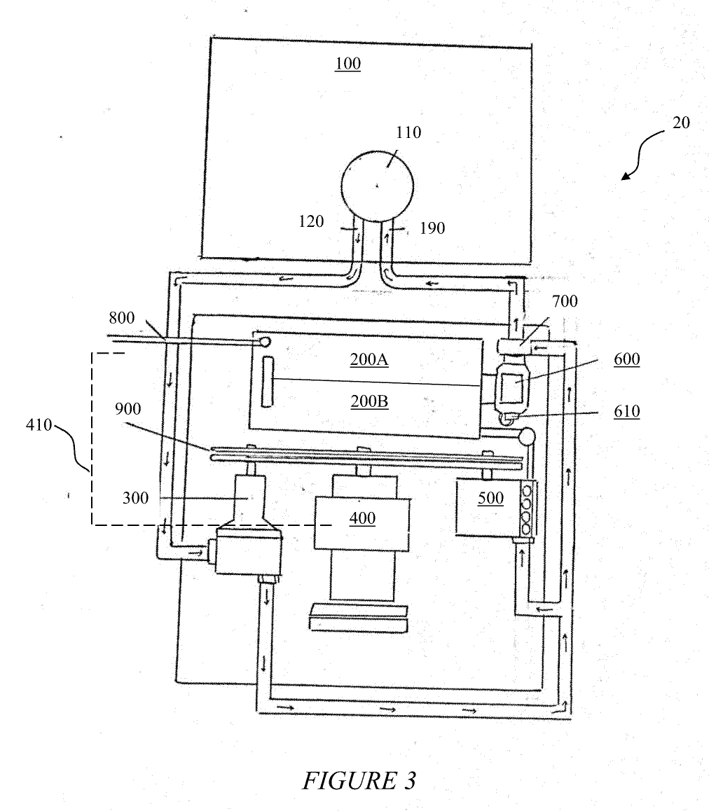

FIG. 3 shows a configuration of a system 20 for delivering a fluid flow with thermal energy to industrial equipment such a radiator fins, according to an embodiment of the disclosure. Although particular structural components are provided in FIG. 3, after reviewing the specification, one of ordinary skill in the art will recognizes that more, fewer, or different component parts may be utilized. The system 20 may be designed in a manner to provide not only durability, but also reliability.

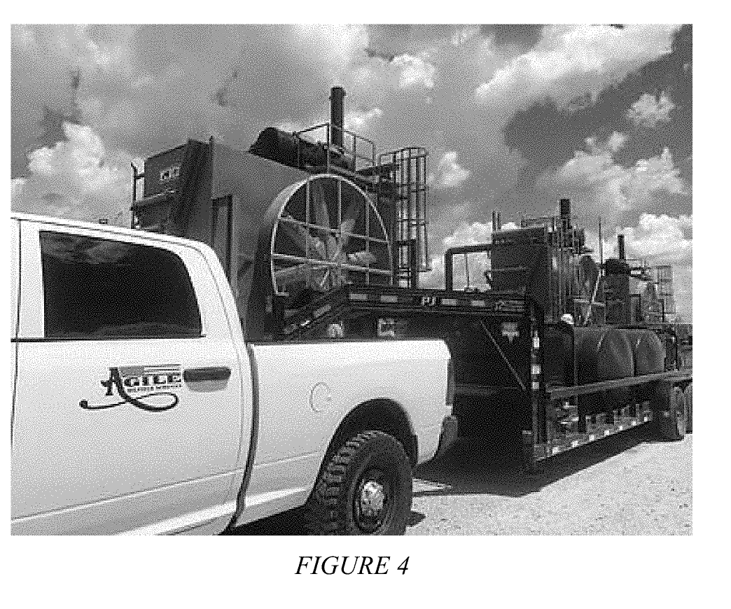

The system 20 may operate in a similar manner to the system described with reference to FIG. 1. In particular configurations, the components of system 20 may be placed on a mobile unit (e.g., on the back of a truck to be brought on location for cleaning), for example, as seen in FIG. 4.

The system 20 includes a water tank 100 that supplies the fluid for ultimate delivery to a pressure outlet line 800. Although a water tank is shown in this configuration, other types of fluids may also be used. And, in some configurations, more than one type of fluid might be used. Water is preferred in certain embodiments because of its environmentally friendly nature and ability to serve as effective thermal energy transfer vehicle.

The water tank 100 has a self-cleaning filter 110, a positive line 120, and a return line 190. The self-cleaning filter 110 filters water that is circulated through the system 20, which is shown as a closed loop. System. As it names implies, the self-cleaning filter 110 automatically cleans itself or clean itself with minimal manual intervention. As to the latter, for example, a self-cleaning system may need maintenance on the order of once every five or so years. Nonetheless, such as system is considered self-cleaning because of low maintenance. Prior to this disclosure, self-cleaning filters 110 have not been used in water cleaning applications.

A variety of commercial off-the shelf categories of self-cleaning filters may be utilized including, but not limited to, backflush, scraper blade, magnetic filters, and the Like. According to one configuration, a self-cleaning filter may be obtained from Rotorflush Limited of Chartmouth, Dorset, UK. Among other things, the self-cleaning filter 110 prevents scaling build-up in the pipes of the system 20 and, also, in the pressure outlet line 800. While a self-cleaning filter 110 has been described in particular configurations, in other configurations, other types of filters may be used. And, while the filtration component has been shown in one particular location, in other embodiments the filtration system may be located at other locations within the system 20.

From the self-cleaning filter 110 and the water tank 100 fluid travels through the positive line 120 to a first pump 300 that generally circulate the fluid through the system 20. The self-cleaning filter 110, itself, may completely receive the energy it needs from the such a first pump. The first pump 300 may be a variety of pumps such a self-priming centrifugal pump, a centrifugal pump, or a prime assisted pump. There are several manufacturers of these types of pumps such as the Gorman-Rupp Company of Mansfield, Ohio as well as other pump manufactures. Prior to this disclosure, centrifugal pumps have not been used in water cleaning applications that also included another pump. More specifically, conventional water cleaning applications typically use a single-pump to provide a high-pressures.

From the first pump 300, the fluid continues where a portion is provided to a second pump, a pressure pump 500, and another portion bypasses the pressure pump 500. The pressure pump 500 increases a pressure on the fluid to a desired pressure, for example, as described above.

Both the pressure pump 500 and the first pump 300 may be powered via a diesel motor 400 and belts 900. Other types of motors may also be used with different fuel. In particular applications, this motor 400 may provide all the energy (e.g., mechanical energy from rotation of the pumps) needed for pressurizing the system 20—avoiding the need for a generator and also providing durability that is expected for oil and gas field applications. In particular embodiments, no electrical systems may be utilized. Rather, mechanical energy, thermal energy, and energy in the form of pressure (e.g., created by the mechanical energy) is utilized.

Although no electrical systems are provided in certain embodiments, other embodiments may have electrical systems. As a non-limiting example, in one configuration, electrical energy may be generated by the motor 400 and provided to a battery (not shown) to provide energy to the diesel pump 610.

A dotted line 410 is shown positioned between a position adjacent the pressure outlet line 800. This dotted line 410 represents a feedback line that dictates whether the system 20 is running or not. In particular, as referenced above, a “dead head” effect can be created by a signal (or lack of a signal) indicating that the motor 400 is off and, accordingly, the pumps 300 and 500 do not operate. This provides a safety feature by preventing pressure build-up of the system—yielding on-demand pressure.

The signal (or lack of a signal) may be as simple as activation mechanism on the nozzle 14, which may be on the end of the pressure outlet line 800. Yet other activation mechanism will become apparent to one of ordinary skill in the art after review of the specification.

From the pressure pump 500, the fluid travels into one or both of the burners 200A and 200B where thermal energy is applied to the fluid to a desired temperature. Two burners 200A, 200B are used in this configuration to not only provide redundancy (to achieve durability), but also to ensure quick application of thermal energy. An associated burner blower 600 and diesel pump 610 assists the application of such thermal energy. The diesel pump 610 is powered by a hydro pump turbine 700 that receives energy from the water flow and converts it to necessary energy used for the diesel pump 610. Although a single burner blower 600 is shown for both burners, two burner blowers may be used in other configurations. Additionally, in particular configurations, a single burner may be used—even if two are present.

The fluid is ultimately provided to the pressure outlet line 800. In particular configurations, any suitable set of sensors within the system 20 may also be utilized to modify the thermal energy and pressure provided to the fluid. For example, as fluid dissipates through the pressure outline line 800, thermal energy and pressure are applied to the replenishment fluid—provided the appropriate signaling (or lack of signaling) indicates that the motor 400 is on

FIG. 4 shows an example of the mobile nature equipment used to carry out the cleaning process, according to an embodiment of the disclosure.

Components in generating such steam may include but are not limited to a thermal energy source to create the steam, a water tank that may refillable, and a chemical tank that includes chemical used in conjunction with water. In certain configurations, these tanks may be mixed. Or, a third tank may be used for the mixtures. Components for delivering the steam may include a hose and a nozzle that selectively releases the steam when activated. In particular configurations, the steam may be 200° F. In other configurations, the steam may be higher or lower.

In particular configurations, both the pressure and temperature of the fluid is closely monitored to reach a desired application of the steam.

Benefits of the particular applications of the fluid cleaning may include, but are not limited to,
Eliminating back splash during cleaning (onto operate, adjacent facilities, and tools, etc.
57% less water consumption and runoffs v. hot water pressure washing
Oil and greasy equipment and surfaces are cleaned more thoroughly
Improved operated safety with less mess and clean up
Reduced chemical usage
Surfaces get cleaner, faster eliminating oily residue.
No damage to fins due to mechanical impact of high pressurized streams of water or steam.
Due to little water in liquid form (and rather in steam), there is no corrosion due to chlorides or weak acid or other chemicals that can be found in water. There is also no need for cleanup sediments such as scale that may remain after washing with water, no waste water treatment, and no water damage to electric motors or to control instruments.

In particular configurations, the steam cleaning oil and gas application may be commercially referred to using the mark, RADIATOR RAPTURE™.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims. As a non-limiting example, while a particular application has been described, the described process may be used with other oilfield applications.

What is claimed is:

1. A system for cleaning industrial equipment, the system comprising.
a tank to store a fluid,
a pump to increase pressure on the fluid;
a burner to increase a temperature of the fluid;
an outlet line to apply the increased temperature and increase pressure fluid as a fluid flow to industrial equipment; and
a self-cleaning filter configured to remove potential contaminants from the fluid.

2. The system of claim 1, further comprising:
a centrifugal pump to circulate the fluid.

3. The system of claim 2, wherein both the pump and the centrifugal pump are powered by a single engine.

4. The system of claim 3, wherein the single engine is only powered when an appropriate signal or a lack of a signal are received.

5. The system of claim 4, wherein the single engine is only powered when an appropriate signal or a lack of a signal is not received.

6. The system of claim 1, wherein the system utilizes no electrical energy.

7. The system of claim 1, wherein the temperature is increased to a temperature between 240° F. and 260° F. at a nozzle on the outlet line.

8. The system of claim 1, wherein the pressure is increased to a pressure of between 290 pounds per square inch and 310 pounds per square at a nozzle on the outlet line.

9. The system of claim 1, wherein the fluid flow is applied to a radiator fin from a nozzle at a rate of at least 12 gallons per minute.

10. A system for cleaning industrial equipment, the system comprising.
a tank to store a fluid,
a first pump to increase pressure on the fluid;
a burner to increase a temperature of the fluid;
an outlet line to apply the increased temperature and increase pressure fluid as a fluid flow to the industrial equipment; and
a second pump to circulate the fluid.

11. The system of claim 10, wherein the second pump is a centrifugal pump.

12. The system of claim 10, wherein both the first pump and the second pump are powered by a single engine.

13. The system of claim 12, wherein the single engine is only powered when an appropriate signal or a lack of a signal are received.

14. The system of claim 10, wherein the system utilizes no electrical energy.

15. The system of claim 10, further comprising:
a filter configured to remove potential contaminants from the fluid.

16. The system of claim 15, wherein the filter is a self-cleaning filter.

17. The system of claim 10, wherein the temperature is increased to a temperature between 240° F. and 260° F. at a nozzle on the outlet line.

18. The system of claim 10, wherein the pressure is increased to a pressure of between 290 pounds per square inch and 310 pounds per square at a nozzle on the outlet line.

19. The system of claim 10, wherein the fluid flow is applied to a radiator fin from a nozzle at a rate of at least 12 gallons per minute.

20. A system for cleaning industrial equipment, the system comprising.
a tank to store a fluid,
a pump to increase pressure on the fluid;
at least two burners to increase a temperature of the fluid;
an outlet line to apply the increased temperature and increase pressure fluid as a fluid flow to the industrial equipment.

21. The system of claim 20, further comprising:
a second pump to circulate fluid.

22. The system of claim 21, wherein both the first pump and the second pump are powered by a single engine.

23. The system of claim 22, wherein the single engine is only powered when an appropriate signal or a lack of a signal are received.

24. The system of claim 20, further comprising:
a filter configured to remove potential contaminants from the fluid.

25. The system of claim 24, wherein the filter is a self-cleaning filter.

26. A method of cleaning a radiator fin, the method comprising:
applying a fluid flow to a radiator fin from a nozzle.
applying energy to increase a pressure of the fluid flow to between 100 pounds per square inch and 500 pounds per square at the nozzle;
applying thermal energy to increase a temperature of the fluid flow to above 200° F. at the nozzle.

27. The method of claim 26, wherein the temperature is increased to a temperature between 240° F. and 260° F. at the nozzle.

28. The method of claim 26, wherein the pressure is increased to a pressure of between 290 pounds per square inch and 310 pounds per square at the nozzle

29. The method of claim 26, wherein the fluid flow is applied to the radiator fin from the nozzle at a rate of at least 12 gallons per minute.

30. The method of claim 26, wherein the fluid flow is a mixture of water in the form of vapor and liquid.
